(19) United States
(12) Patent Application Publication
(10) Pub. No.: US 2004/0026460 A1
(43) Pub. Date: Feb. 12, 2004

(54) Fluid soap and air freshener dispenser

(76) Inventor: Abdul Ebrahim Patel, London (GB)

Correspondence Address: MILLER NASH LLP, 4400 TWO UNION SQUARE, 601 UNION STREET, SEATTLE, WA, 98101-2352, US

(21) Appl. No.: 10/415,131

(22) PCT Filed: Oct. 16, 2001
(86) PCT No.: PCT/GB01/04614

(30) Foreign Application Priority Data
Dec. 26, 2000 (GB) 0026229.5

(51) Int. Cl. G01F 11/06

(52) U.S. Cl. 222/321.9; 222/192

(57) ABSTRACT

A liquid soap container 10, 20, 40 and 51 comprising of a dispensing pump 13, 23, 33, and 49 which incorporates a pressurised air freshener canister 11,35, 46 and 53 or a liquid air freshener container 21. When a dispensing pump 13, 23,33 and 49 is depressed it also activates the valve of a pressurised air freshener canister 11, 35, 46, 53 or a liquid air freshener container 21 to refresh the air whilst at the same time dispensing the liquid or gel soap. After the action of depressing the pump 13,23, 33 and 49 has stopped the release of the air freshener from 11, 35,46,53 and 21 also stops. Both systems work simultaneously. An air vent casing 12 22, 39, 47, and 53 help secure the air freshener canister 11,35,46 and 53 or the liquid air freshener container 21, and also temporarily contain the released air freshener before it vaporises or evaporates in to the atmosphere. This air vent casing also acts as a safety feature to prevent accidental spraying on someone. A method to engage or disengage, connect or disconnect the supply of air freshener when the dispensing pump 13,23,33, and 49 is activated to dispense soap. The incorporation of a solid air freshener to work along with a gas and/or liquid air freshener so as to provide continuous fragrance action.

### BACKGROUND OF INVENTION

This invention relates to a liquid soap and an air freshener dispenser.

Liquid soaps and air fresheners on their own are well known. A liquid soap comprises of a container usually made of HDPE, PVC, or PET. The container has a dispensing pump which is screwed on to the neck of the container which when depressed dispenses the liquid soap in the container.

An airfreshener comes in many forms and designs but technically all perform the same task i.e. to make a confined space e.g. a toilet, bathroom, kitchen etc. to smell more pleasantly by neutralising an offensive odour and replace that with a pleasant smell. Air fresheners come in a solid gel, liquid, or pressurised gas canister.

These two systems of washing hands and deodorising a room at this moment in time is relatively expensive as a consumer has to purchase both separately. Moreover the use of an air freshener in the gas canister or a liquid form become active only when a person physically takes the canister in his hand and sprays the room. In the liquid airfreshener system a person has to pour the liquid perfume on to a sponge or potpourri.

Both of these acts are by human nature forgetful especially in a bathroom, toilet, kitchen, commercial or public environment. A person is almost certain to wash his hands after using the toilet or after cooking in a kitchen and it is this habit that is being utilised to create the invention.

### SUMMARY OF INVENTION

The object of this invention is to provide a product which combines both features in one by using our human habit of washing hands to activate an air freshener with the use of a dispensing pump. This system provides advantages in cost and effective use of an air freshener as this invention automatically dispenses not only the liquid soap but also activates an air freshener. This invention also fills a gap in the market as at present both products have to be purchased separately. This invention is of particular use in a toilet situation where washing hands with an antibacterial soap and deodorising the toilet can be achieved in one simple step.

The volume of dispensation of the liquid soap may correspond to the volume of dispensation of the air freshener so that when the liquid soap has emptied out so too has the air freshener.

Though reference is being made to liquid soap in the description, title, and abstract the scope of the invention also includes soaps that are essentially liquid but for thickeners and/or gelling agents that are incorporated in the soap formulation to make the soap a gel or semi liquid/gel soap. The scope of the invention is thus not limited to soaps in liquid form.

Further though reference is being made to gas and liquid air fresheners in this description, a useful feature in this concept is the incorporation of a solid or gel air freshener as well within the apparatus described herein. This method allows a complete product in that the solid/gel air freshener will have continuous fragrance action whilst the gas or liquid air freshener will give a burst of air freshener when soap is dispensed.

Yet another feature within the scope of this invention is a method to disengage, disconnect, or remove the dispensation of air freshener when the dispensation of soap is activated. This feature is helpful in that it gives a user a choice whether or not to activate the dispensation of air freshener when the soap dispensing pump is activated. This avoids wastage of air freshener when a user might feel he does not need it. A further advantage of this feature is that it makes the apparatus in the invention more marketable.

The uses of this product will not only be limited to domestic households but would be of effective use in commercial and public premises e.g. office buildings, public toilets, hotels etc. As well as potential uses in all modes of transport e.g. Aeroplanes, trains, ships etc.

Preferred embodiments of the invention will now be described, by way of example using a domestic type of dispensing pump though the concept as it applies to a commercial type dispensing pump is the same.

### BRIEF DESCRIPTION OF THE SEVERAL VIEWS OF THE DRAWINGS

References to the accompanying drawings are made in which:

FIG. 1. Shows the side view of the liquid soap container with its dispensing pump and the pressurised canister of air freshener incorporated along the side wall of the liquid soap container and air vent casing.

FIG. 2. Shows the horizontal plain view of the liquid soap container to demonstrate how the pressurised canister is incorporated within the liquid soap container and the air vent casing.

FIG. 3. Illustrates the invention in action with the dispensing pump being in a depressed position that allows the liquid soap to be dispensed from the pump. At the same time the lever is adapted so that the dispensing pump activates the pressurised canister valve releasing the air freshener within the air vent casing.

FIG. 4. Illustrates that once the dispensing pump is no longer depressed the air freshener canister too is no longer activated. Both systems work simultaneously.

FIG. 5. Illustrates the same example as in FIG. 1 except that this is adapted to a liquid air freshener system.

FIG. 6. Illustrates the same as FIG. 3 except that it shows the liquid air freshener being dispensed and subsequently absorbed by a sponge that helps to evaporate the air freshener.

FIG. 7. Illustrates the same as FIG. 4 as it applies to a liquid air freshener container system.

FIG. 8. Shows a detailed view of the mechanisms involved in activating the liquid air freshener system.

FIG. 9. In this method the supply of soap 31 is filled in its container 32, the supply of soap is dispensed by means of dispensing pump 33 by manually pushing its dispensing handle 34. This action puts pressure on the air freshener container 35 by means of disc 36. This in turn will activate the air freshener valve 37 which dispenses the air freshener 39. The released air freshener will now escape through rented holes 32. Any excess air freshener that does not escape will be absorbed by an absorbent material 41.

FIG. 10. Shows the concept being applied to different shape of container 42. Here the diagram, shows the invention in action. Soap 43 is dispensed by depressing the pump which in turn releases air freshener 44 from its valve 45. The air freshener container 46 sits within the vented casing 47. Any excess vapour is absorbed by absorbent material 48.

FIG. 11. Shows the invention does not necessarily used a lever to activate the air freshener. Here the action of depressing the pump 49 causes the dispensation of soap 50 contained in its container 51. The action of depressing the pump will put pressure on the valve of the air freshener container 52, there by releasing air freshener within its vented casing 53.

FIG. 12. Shows a method that enables the disconnection of the supply of air freshener when the supply of soap is activated. Here an additional stopper 54 is placed within the lever. When the disc 55 is aligned to face the lever, the air freshener is disconnected as depressing the soap pump will not allow the lever to travel further down to press directly or indirectly against the valve of the air freshener. Soap will be dispensed without the air freshener.

FIG. 13. Shows if the disc is rotated away from the lever this will now allow the lever to travel fully to press directly or indirectly against he valve of the air freshener thereby activating the dispensation of the air freshener.

FIG. 14. Shows the incorporation of a solid or gel air freshener 56 with a gas canister airfreshener so that the two systems of air freshener complement each other. The solid/gel air freshener will have continuos fragrance action whilst the gas or liquid air freshener will give a burst of air freshener the dispensing pump for soap is activated.

### DETAILED DESCRIPTION OF INVENTION

Gas Canister System

Referring to the drawing in FIG. 1 the liquid soap container 10, has been specially designed to accommodate the air freshener canister 11, which sits along side the air vent casing 12. The dispensing pump 13 has a lever 14 that activates the valve of the gas air freshener canister 11.

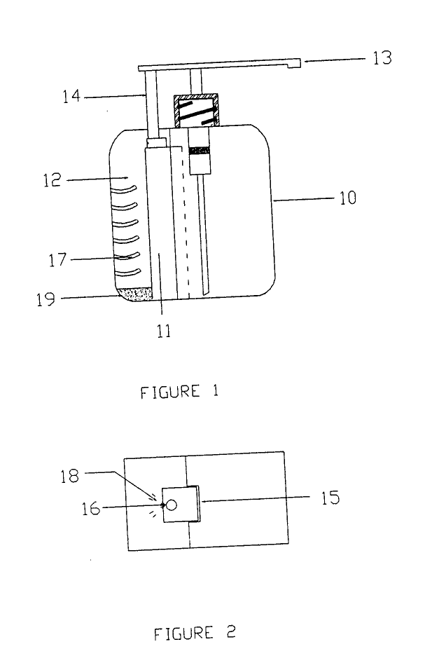

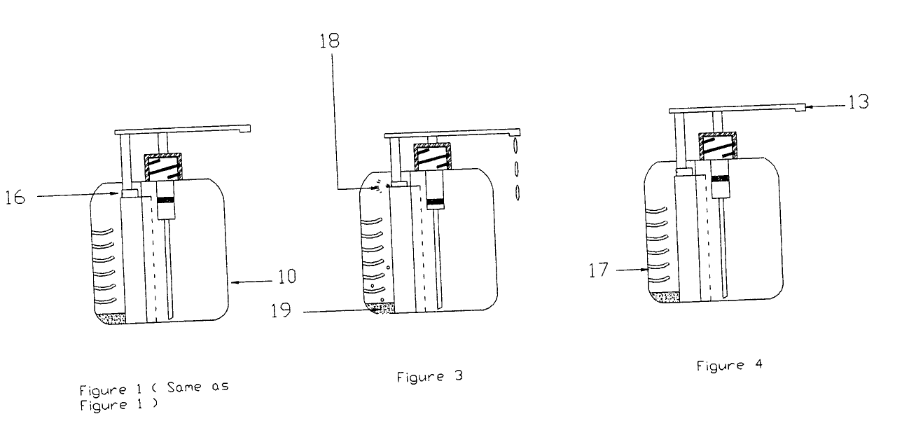

Referring to the drawing in FIG. 2 the gas air freshener is held laterally within the liquid soap container by a vertical notch 15.

Referring to FIG. 3 the lever 14 has now depressed the gas canister which activates is valve and sprays from its pin hole 16 within the air vent casing that is fully formed i.e. without air vents at that position to prevent spraying on to the walls or directly into the atmosphere. Below the position of the spray pin hole 16 are air vents 17 for the air freshener vapour 18 to escape through into the atmosphere.

At the bottom of the gas canister is an absorbent material 19 which absorbs any further vapour that has not escaped through the air vents 17.

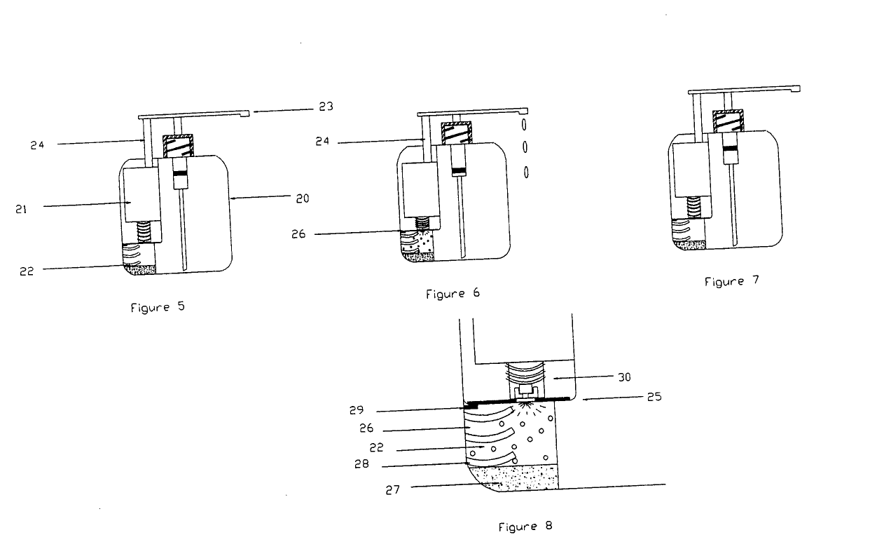

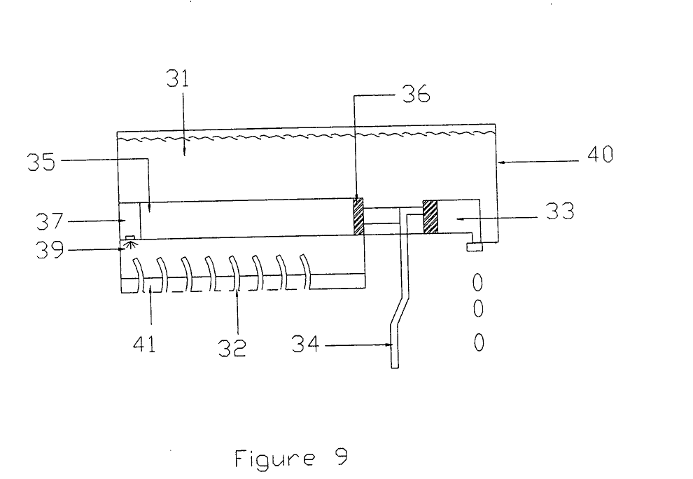

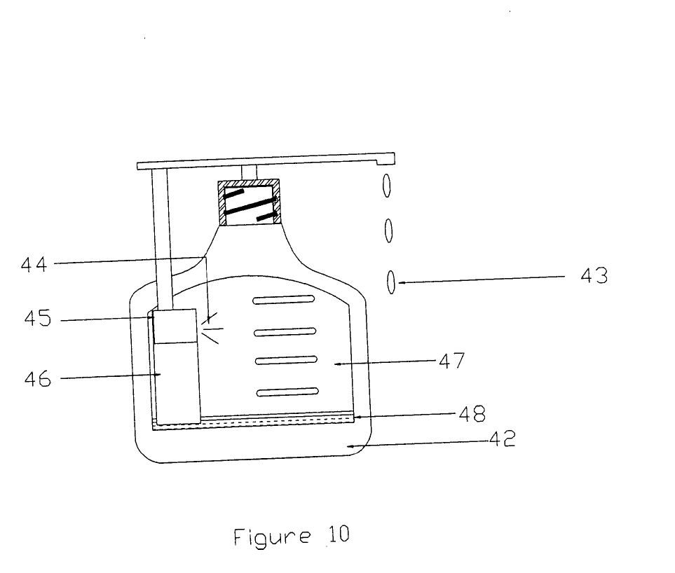

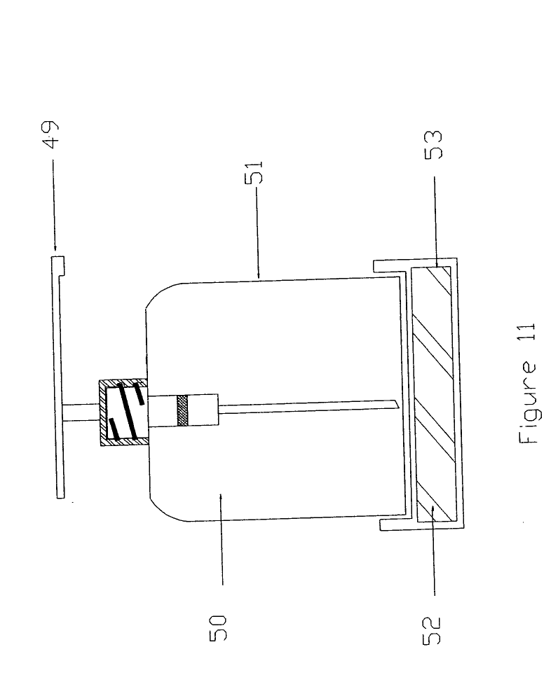

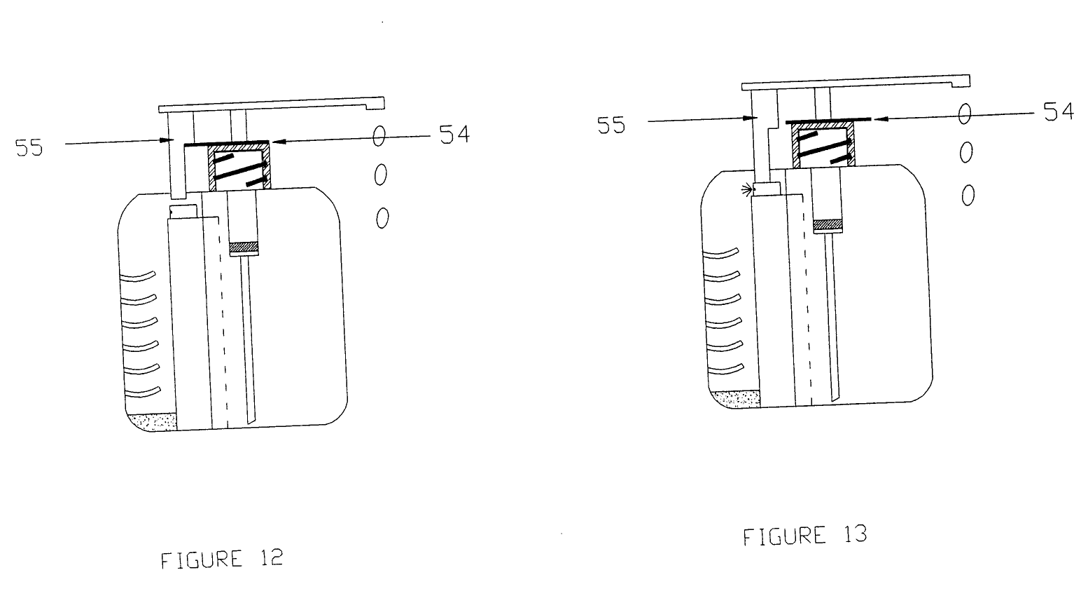

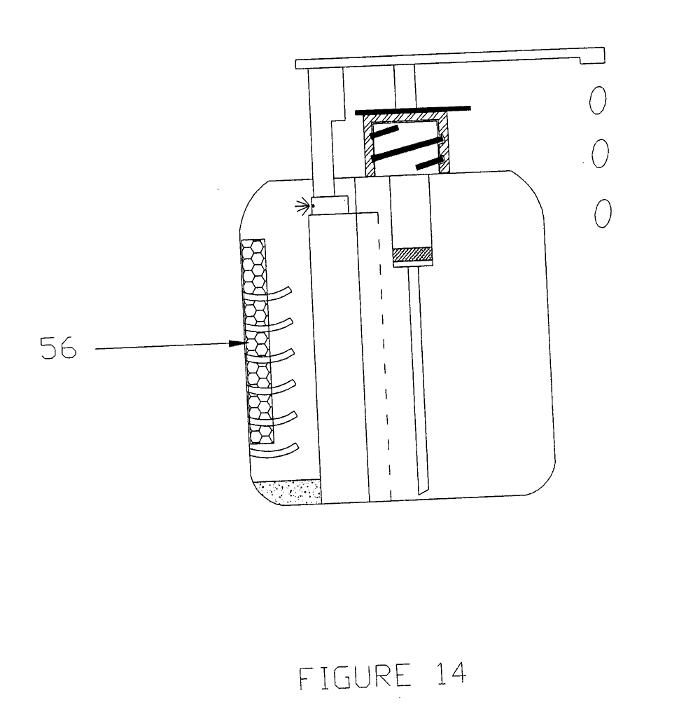

Referring to the drawing in FIG. 4 once the dispensing pump 13 is no longer depressed a spring within the dispensing pump pushes it upwards and thereby simultaneously deactivate the valve of the gas canister. The system is now ready for a second application.

Liquid Air Freshener System

Referring to the drawing in FIG. 5 the liquid soap container 20 has been especially designed to accommodate the liquid air freshener container 21 which sits snugly in between the liquid soap container 20 and the air vent casing 22. The dispensing pump 23 has a lever 24 that when depressed activates the valve of the liquid air freshener container 21.

Referring to the drawing in FIG. 6 and 8 the liquid air freshener slides up and down vertically up to a notch 25 on the liquid soap container 20 and a corresponding notch 26 on the air vent casing 22. The dispensing pump 23 when depressed also pushes an adapted lever 24 vertically downwards which then activates the liquid air freshener valve to spray directly on to the sponge 27. The liquid air freshener droplets now on the sponge evaporates through the air vents 28.

Referring to the drawing in FIG. 8 the liquid air freshener is dispensed by means of the notches 25 and 26 pressing on to a releasing ring 29 via a spring 30 that activates the air freshener valve and sprays on to an absorbent material. The spring 30 is located at the neck of the liquid air freshener container 21 and sits between the notches 25 and 26 and the shoulder of the liquid air freshener container. The function of the releasing ring 29 is to activate the valve of the liquid air freshener container as it is pressed downwards on to the notches 25 and 26.

The function of the spring 30 is to bring back the liquid air freshener container to its normal resting position and thereby deactivate the valve from releasing any further liquid air freshener. This mechanism will work simultaneously with the up and down movement of the dispensing pump.

1. Apparatus comprising a container for liquid soap, a user operable pump for dispensing liquid soap from the container therefor, and a container for air freshener comprising a valve operable to release air freshener from the container therefor, the apparatus being arranged such that operation of the pump to dispense liquid soap causes operation of the valve to release air freshener.

2. Apparatus as claimed in claim 1 further comprising a vented casing into which air freshener is released from the container for air freshener, and from which released air freshener can escape into the atmosphere.

3. Apparatus as claimed in claim 1 further comprising a vented casing into which air freshener is released from the container for air freshener, and from which released air freshener can escape into the atmosphere wherein the container for air freshener is accommodated within the casing.

4. Apparatus as in claimed in claim 1 further comprising a vented casing into which air freshener is released from the container for air freshener, and from which released air freshener can escape into the atmosphere wherein the container for air freshener is accommodated within the casing and slidably mounted relative to the casing and/or container for liquid soap.

5. Apparatus as claimed in claim 1 further comprising a vented casing into which air freshener is released from the container for air freshener, and from which released air freshener can escape into the atmosphere wherein the container for air freshener is accommodated within the casing and slidably mounted relative to the casing and/or container for liquid soap, and the container for liquid soap comprises notches to arrest sliding movement of the container for air freshener.

6. Apparatus as claimed in claim 1 further comprising a vented casing into which air freshener is released from the container for air freshener, and from which released air freshener can escape into the atmosphere wherein the casing is arranged to prevent spraying of air freshener directly into the atmosphere.

7. Apparatus as claimed in claim 1 comprising a material to absorb excess air freshener.

8. Apparatus as claimed in claim 1 further comprising a vented casing into which air freshener is released from the container for air freshener, and from which released air freshener can escape into the atmosphere and a material to absorb air freshener, wherein the absorbent material sits in a cavity between the container of liquid soap and the casing.

9. Apparatus as claimed in claim 1 wherein the container for air freshener is a pressurised gas canister.

10. Apparatus as claimed in claim 1 wherein the container for air freshener is a liquid air freshener container.

11. Apparatus as claimed in claim 1 wherein the container for soap is a liquid soap or gel soap container.

12. Apparatus as claimed in claim 1 comprising a release ring operative to operate the valve of the container for air freshener when the pump is operated.

13. Apparatus as claimed in claim 1 comprising a spring operative to close the valve of the air freshener container.

14. Apparatus as claimed in claim 1 wherein the size of the containers for liquid soap and for air freshener and the volume of soap and air freshener dispensed when the pump is operated are selected so that when the container for liquid soap has emptied so too has the container for air freshener.

15. Apparatus as claimed in claim 1 wherein the pump comprises a lever operative to operate the valve for the container for air freshener.

16. Apparatus as claimed in claim 1 wherein the container for air freshener is accommodated within or adjacent to the container for liquid soap.

17. Apparatus as claimed in claim 1 comprising an arrangement to allow a user to selectively prevent the dispensation of air freshener when the pump for dispensing liquid soap is activated.

18. Apparatus as claimed in claim 1 comprising a solid or gel air freshener and a gas and/or liquid air freshener.
